(19) United States
(12) Patent Application Publication
(10) Pub. No.: US 2024/0053606 A1
(43) Pub. Date: Feb. 15, 2024

(54) DISPLAY UNIT AND OPTICAL DISPLAY DEVICE

(71) Applicant: SEIKO EPSON CORPORATION, Tokyo (JP)

(72) Inventors: Mitsutaka IDE, SHIOJIRI-SHI (JP); Yuiga HAMADE, MATSUMOTO-SHI (JP)

(73) Assignee: SEIKO EPSON CORPORATION, Tokyo (JP)

(21) Appl. No.: 18/446,458

(22) Filed: Aug. 8, 2023

(30) Foreign Application Priority Data
Aug. 10, 2022 (JP) 2022-128476

(51) Int. Cl. G02B 27/01; G02B 23/00

(52) U.S. Cl. CPC G02B 27/0101; G02B 23/00; G02B 2027/0132

(57) ABSTRACT

A display unit includes a mounting member mounted on a first accommodation member configured to accommodate a lens group including an objective lens and an eyepiece, a display element that emits video light, a first deflection member that deflects the video light from the display element, and a second accommodation member configured to accommodate the display element and the first deflection member. The second accommodation member is mounted on the first accommodation member, such that the first deflection member is disposed on an axis of the lens group, by the mounting member. When the first deflection member is disposed on the axis of the lens group, an axis of the video light deflected by the first deflection member overlaps with the axis of the lens group.

The present application is based on, and claims priority from JP Application Serial Number 2022-128476, filed Aug. 10, 2022, the disclosure of which is hereby incorporated by reference herein in its entirety.

### BACKGROUND

### 1. Technical Field

The present disclosure relates to a display unit and an optical display device.

### 2. Related Art

In recent years, there has been an increasing demand for an observer using an observation apparatus such as binoculars, a telescope, or a microscope to observe an observation image and a video in a superimposed manner. For example, it is desired to realize a function of instantaneously displaying a name of a wild bird as a video on an observation image when the wild bird is observed with binoculars or a function of instantaneously displaying a magnification as a video on an observation image of a microscope.

JP-A-2019-174569 discloses an optical device including a first objective lens, a second objective lens, an eyepiece, a beam splitter, and a display. In the optical device disclosed in JP-A-2019-174569, video light emitted from a display passes through the second objective lens, and is superimposed on observation light after passing through the first objective lens by the beam splitter disposed between the first objective lens and the eyepiece on an optical path of the observation light. An intermediate image is formed between the beam splitter and the eyepiece on the optical paths of the observation light and the video light. As a result, an observer using the optical device of JP-A-2019-174569 can visually recognize the intermediate image in which the observation image and the video light are superimposed on each other.

In the optical device disclosed in JP-A-2019-174569, a display (a display element) for emitting video light, the second objective lens, and the beam splitter are previously and directly incorporated between the first objective lens and the eyepiece on the optical path of observation light. Therefore, it is difficult to combine a second optical system (a display unit) including the display, the second objective lens, and the beam splitter with a first optical system that has the first objective lens and forms an observation image later. Therefore, even when there is already an observation device with which an observer is accustomed to use or an observation device corresponding to special conditions or required performance, it is difficult to perform observation by superimposing observation light and video light using such an observation device as disclosed in JP-A-2019-174569.

### SUMMARY

According to an aspect of the present disclosure, there is provided a display unit including a mounting member mounted on a first accommodation member configured to accommodate a lens group including an objective lens and an eyepiece, a display element that emits video light, a first deflection member that deflects the video light from the display element, and a second accommodation member configured to accommodate the display element and the first deflection member, wherein the second accommodation member is mounted on the first accommodation member, such that the first deflection member is disposed on an axis of the lens group, by the mounting member, and when the first deflection member is disposed on the axis of the lens group, an axis of the video light deflected by the first deflection member overlaps with the axis of the lens group.

### BRIEF DESCRIPTION OF THE DRAWINGS

FIG. 1 is a schematic diagram of an optical display device according to a first embodiment of the present disclosure.

FIG. 2 is a schematic diagram of the optical display device illustrated in FIG. 1 when seen in a direction D.

FIG. 3 is a schematic diagram of an optical display device according to a second embodiment of the present disclosure.

FIG. 4 is a schematic diagram of an optical display device according to a third embodiment of the present disclosure.

FIG. 5 is a schematic diagram of an optical display device according to a fourth embodiment of the present disclosure.

FIG. 6 is a schematic diagram of an optical display device according to a fifth embodiment of the present disclosure.

FIG. 7 is a schematic diagram of an optical display device according to a sixth embodiment of the present disclosure.

FIG. 8 is a schematic diagram of an optical display device according to a seventh embodiment of the present disclosure.

FIG. 9 is a schematic diagram of an optical display device according to an eighth embodiment of the present disclosure.

### DESCRIPTION OF EMBODIMENTS

### First Embodiment

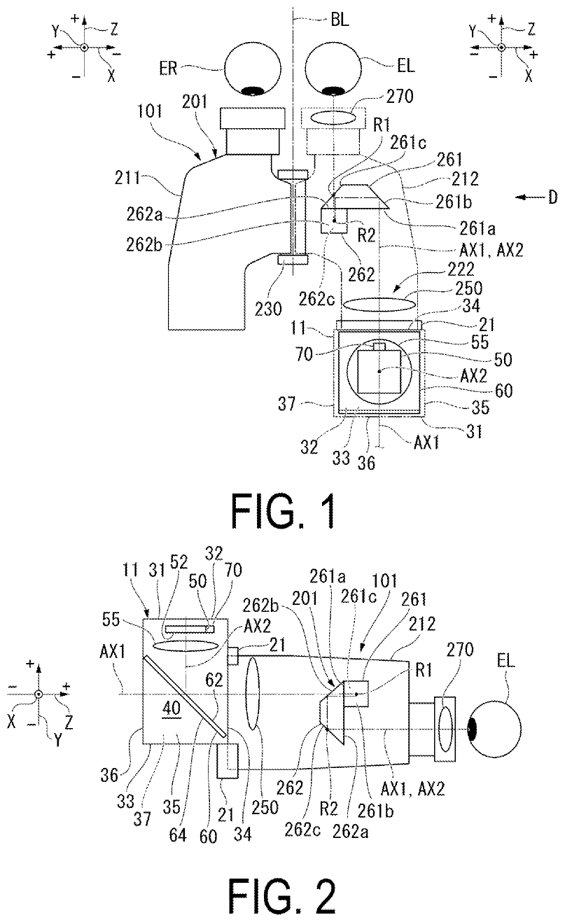

A first embodiment of the present disclosure will be described below with reference to FIGS. 1 and 2. FIG. 1 is a schematic diagram illustrating a configuration of an optical display device 101 according to a first embodiment of the present disclosure, and is a diagram when the optical display device 101 is seen from above. In each of the drawings below, the scale of the dimensions may be changed depending on the components in order to make each of the components easier to see.

As illustrated in FIG. 1, the optical display device 101 includes binoculars (a long distance viewing device) 201 and a display unit 11 according to the first embodiment.

In the specification, a direction parallel to a line (not illustrated) connecting centers of a right eye ER and a left eye EL of an observer using the binoculars 201 is defined as an X direction, and a virtual line passing through an intermediate position between the center of the right eye ER and the center of the left eye EL and extending parallel to a forward and rearward direction of the field of view of the right eye ER and the left eye EL is defined as a reference line BL. In the X direction, a direction approaching the reference line BL may be referred to as a −X direction, and a position relatively close to the reference line BL may be referred to as a position on the −X side. A direction away from the reference line BL may be referred to as a +X direction, and a position relatively far from the reference line BL may be referred to as a position on the +X side.

In addition, a direction orthogonal to the X direction and parallel to the forward and rearward direction of the field of view of the right eye ER and the left eye EL is defined as a Z direction. In the Z direction, a direction from a position at which an object (not illustrated) to be observed is present toward the right eye ER and the left eye EL of the observer may be referred to as a +Z direction, and a direction opposite to the +Z direction may be referred to as a −Z direction. A relatively forward position in the +Z direction may be referred to as a position on the +Z side or a position on the image side, and a relatively rearward position in the +Z direction, that is, a forward position in the −Z direction may be referred to as a position on the −Z side or a position on the object side. Further, a direction orthogonal to the X direction and the Z direction and parallel to a vertical direction is defined as a Y direction. In the Y direction, a direction from bottom to top may be referred to as a +Y direction, and a direction opposite to the +Y direction may be referred to as a −Y direction. A relatively forward position in the +Y direction may be referred to as a position on the +Y side or a position of the upper side, and a relatively rearward position in the +Y direction, that is, a forward position in the −Y direction may be referred to as a position on the −Y side or a position on the lower side.

Hereinafter, observation light represents light emitted from an object to be observed and visually recognized by the observer through the binoculars 201. Video light is image light representing information on the object to be observed, and represents light emitted from a display element 50, which will be described below, and visually recognized through the binoculars 201 by an observer.

The binoculars 201 are not so-called mini-polo type binoculars but ordinary polo type binoculars among the so-called polo type or polo prism type binoculars. The binoculars 201 include a lens barrel (a first accommodating member) 211 and a lens group for the right eye, a lens barrel (a first accommodating member) 212 and a lens group 222 for the left eye, and a connecting member 230.

The lens group for the right eye is accommodated in the lens barrel 211 for the right eye. The lens group 222 for the left eye is accommodated in the lens barrel 212 for the left eye. A shape of each of the lens barrels 211 and 212 is appropriately designed according to the overall shape of the lens group corresponding to each of the lens barrels. Specifically, each of the lens barrel 211 and 212 extends in the +Z direction from an end on the object side, bends in the −X direction while spreading downward, and extends in the +Z direction to an end on the image side. The lens barrel 211 for the right eye is equivalent to the lens barrel 212 for the left eye folded with reference to the reference line BL. The end of the object side and the end of the image side end in each of the lens barrels 211 and 212 are open. That is, each of the lens barrels 211 and 212 is a cylindrical housing.

Although the lens group for the right eye is omitted in FIG. 1, the lens group for the right eye is equivalent to the lens group 222 for the left eye folded with reference to the reference line BL. Hereinafter, only the lens group 222 will be described.

The lens group 222 includes at least an objective lens 250 and an eyepiece 270. The objective lens 250 is an optical element disposed closest to the image side in the lens group 222, and is fitted to an end portion of the lens barrel 212 on the object side. The eyepiece 270 is an optical element disposed closest to the image side, that is, closest to the left eye EL in the lens group 222, and is fitted to an end portion of the lens barrel 212 on the image side. In FIG. 1, each of the objective lens 250 and the eyepiece 270 is illustrated as a single biconvex lens. However, one or both of the objective lens 250 and the eyepiece 270 may be a compound lens in which a plurality of lenses are disposed at intervals on an axis AX1 of the lens group 222, a cemented lens in which two or more lenses are cemented to each other on the axis AX1, or a combination of a compound lens and a cemented lens. The axis AX1 means an optical axis of the observation light and the video light passing through the entire lens group 222.

Further, the lens group 222 may include prisms 261 and 262. The prism 261 is disposed between the objective lens 250 and the eyepiece 270 on the optical path of the observation light (not illustrated), that is, on the axis AX1. The prism 261 has a substantially quadrangular shape when seen in the X direction, a substantially trapezoidal shape when seen in the Y direction, and an elliptical shape when seen in the Z direction.

The prism 261 has a transmission surface 261a and reflection surfaces 261b and 261c. The transmission surface 261a is a plane parallel to an XY plane including the X direction and the Y direction, and transmits the observation light and the video light described below. The reflection surface 261b is a curved surface that is curved to be convex to the +X side when moving in the Y direction and moves to the −X side when moving in the +Z direction. The reflection surface 261c is a curved surface that is curved to be convex to the −X side when moving in the Y direction and moves to the +X side when moving in the +Z direction. The reflection surfaces 261b and 261c totally reflect the observation light and the video light.

The prism 262 is disposed immediately after the prism 261 on the axis AX1, that is, at a position on the image side of the prism 261 on the axis AX1. In actuality, the prism 262 overlaps a portion of the prism 261 on the −X side with respect to a center thereof in the X direction, overlaps a portion of the prism 261 on the lower side with respect to the center in the Y direction, protrudes downward with respect to the prism 261, and is disposed at a position on the −Z side with respect to the prism 261 in the Z direction. A transmission surface 262a of the prism 262 is disposed parallel to the transmission surface 261a of the prism 261, and is disposed with a gap from the transmission surface 261a in the Z direction.

The prism 262 has the transmission surface 262a and reflection surfaces 262b and 262c. The transmission surface 262a is a plane parallel to the XY plane and transmits the observation light and the video light. The reflection surface 262b is a curved surface that is curved to be convex to the +Y side when moving in the X direction and moves to the +Y side as moving in the +Z direction. The reflection surface 262c is a curved surface that is curved to be convex to the −Y side when moving in the X direction and moves to the −Y side as moving in the +Z direction.

Each material of the objective lens 250, the prisms 261 and 262, and the eyepiece 270 is not particularly limited as long as the observation light and the video light can be transmitted therethrough, and is, for example, optical glass, quartz, or the like.

FIG. 2 is a schematic diagram illustrating a configuration of the optical display device 101 when seen in a direction D illustrated in FIG. 1. As illustrated in FIGS. 1 and 2, the display unit 11 includes a mounting member 21, a housing (a second accommodation member) 31, a display element 50, a lens 55, and a half mirror (a first deflection member) 60.

The mounting member 21 is a member that is mounted on an end portion of the lens barrel 212 of the binoculars 201 on the object side from the object side, that is, the −Z side, and is attachable to and detachable from the lens barrel 212. The configuration and shape of the mounting member 21 are not particularly limited as long as the mounting member 21 is attachable to and detachable from the end portion of the lens barrel 212 on the object side. The mounting member 21 is, for example, a member that can lock the end portion of the lens barrel 212 on the object side from the outside in the radial direction. When seen in the Z direction, the mounting member 21 does not overlap at least the optical path of the observation light before the observation light is incident on the objective lens 250.

The display element 50, the lens 55, the half mirror 60, and a signal processing device 70 are accommodated in the housing 31. The housing 31 is appropriately designed according to the overall shape and size of the optical system including the lens 55 and the half mirror 60 for superimposing the video light emitted from the display element 50 on the observation light.

Specifically, the housing 31 is formed in a rectangular parallelepiped shape, and includes an upper wall portion 32, a bottom wall portion 33, and side wall portions 34, 35, 36 and 37. The upper wall portion 32 has an inner wall surface and an outer wall surface substantially parallel to the XY plane, and is located above the lens barrel 212. The bottom wall portion 33 has an inner wall surface and an outer wall surface substantially parallel to the XY plane, and is located below a lower end of the half mirror 60.

The side wall portion 34 has an inner wall surface and an outer wall surface substantially parallel to the XZ plane including the X direction and the Z direction, is located on the +Z side, that is, at a position on the image side with respect to an end of the half mirror 60 on the +Z side, and is disposed adjacent to an end of the lens barrel 212 on the object side in the Z direction. A transmission region is provided in a region on the side wall portion 34 that overlaps the optical paths of the observation light and the video light. The side wall portion 36 has an inner wall surface and an outer wall surface that are substantially parallel to the XZ plane, and is located on the −Z side, that is, the object side with respect to an end of the half mirror 60 on the −Z side. A transmission region is provided in a region on the side wall portion 36 that overlaps the optical path of the observation light.

The side wall portion 35 has an inner wall surface and an outer wall surface that are substantially parallel to a YZ plane including the Y direction and the Z direction, connects ends of the upper wall portion 32 and the bottom wall portion 33 on the +X side to each other, and connects ends of the side wall portions 34 and 36 on the +X side to each other. The side wall portion 37 has an inner wall surface and an outer wall surface that are substantially parallel to the YZ plane, connects ends of the upper wall portion 32 and the bottom wall portion 33 on the −X side to each other and connects ends of the side wall portions 34 and 36 the −X side to each other.

A material of the housing 31 is not particularly limited. However, when the material of the housing 31 is a material that does not transmit the observation light and the video light or a material that hardly transmits the observation light and the video light, an opening is formed in the transmission region of each of the side wall portions 34 and 36, or only the transmission region is formed of a material that can transmit the observation light and the video light. It is preferable that the inner wall surface of each of the upper wall portion 32, the bottom wall portion 33, and the side wall portions 35 and 37 and the inner wall surface of the region other than the transmission region of the side wall portions 34 and 36 be subjected to a light shielding treatment such as thread cutting or black coating. It is possible to curb irregular reflection of the video light emitted from the display element 50 on the inner wall surfaces and to prevent occurrence of a ghost by performing the light shielding treatment on the inner wall surfaces.

The display element 50 is disposed in an internal space 40 of the housing 31, and specifically, disposed at a predetermined position on the +Y side in the internal space 40. The display element 50 has a display surface 52 that emits the video light. The display surface 52 is disposed parallel to the XZ plane and faces the internal space 40. The display element 50 may be provided on an inner wall surface of the upper wall portion 32, that is, a wall surface facing the internal space 40.

The side wall portions 34 and 36 may be omitted in the housing 31, and the housing 31 may be open toward the +Z side and the −Z side. The side wall portions 34 and 36 prevent a hand of the observer from touching the display element 50, the lens 55, and the half mirror 60 when the observer handles the display unit 11. As a result, it is possible to prevent a variation of an inclination angle of the half mirror 60, a deviation of an axis AX2 due to the variation, and occurrence of external impact on and damage to each of the display element 50, the lens 55, and the half mirror 60. In addition, a dust-proof effect with respect to the internal space 40 can be obtained by providing the side wall portions 34 and 36.

The display element 50 is preferably a self-luminous element such as an organic light emitting diode (OLED) or a laser micro electro mechanical system (MEMS) as a light source capable of emitting video light so as not to affect the observation light when the video light is superimposed on the observation light as will be described below. It is possible to prevent occurrence of so-called black floating in the video light and to clearly display the video light using the light sources in the display element 50. However, when the black floating of the video light is not a problem, the display element 50 may be, for example, a liquid crystal on silicon (LCoS, registered trademark), a light emitting diode (LED), a liquid crystal display (LCD), or a combination of the LED and the LCD.

The lens 55 is disposed in the internal space 40 of the housing 31, and specifically, the lens 55 is disposed at a predetermined position in front of, that is, below and on the −Y side of the display element 50 on the optical path of the video light emitted from the display element 50. The lens 55 forms an image of the video light in front of the lens 55 on the optical path. The lens 55 may be a biconvex lens as illustrated in the drawing, or may be any one of a rotationally symmetric spherical lens including a plano-convex lens other than the biconvex lens, an aspherical lens, a free-form surface lens, and a diffraction lens including a Fresnel lens. In addition, the lens 55 may be a compound lens in which a plurality of lenses are disposed at intervals on the axis AX2 of the lens 55, may be a cemented lens in which two or more lenses are cemented to each other on the axis AX2, or may be configured of a combination of the compound lens and the cemented lens. The axis AX2 means the optical axis of the video light passing through the lens 55. Parameters including a shape and a numerical aperture (NA) of the lens 55 are appropriately designed in consideration of a size of the display surface 52, a beam area and a wavelength of the video light, and the like.

A material of the lens 55 is not particularly limited as long as it can transmit the video light, and for example, the material may be optical glass, quartz, or the like, or may be a resin such as plastic.

Preferably, a distance between the lens 55 and the display element 50 on the axis AX2 is finely adjustable. For example, a position of the display element 50 on the axis AX2 may be fixed and a position of the lens 55 on the axis AX2 may be movable, or a moving mechanism (not illustrated) may be provided in the lens 55. For example, when focal lengths and the imaging positions of the observation light and the video light are deviated from each other, the focal lengths and the imaging positions of the observation light and the video light can be aligned with each other by adjusting the distance between the lens 55 and the display element 50 on the axis AX2. In addition, even when a position of an object to be observed changes suddenly, or when the optical display device 101 is shared by a plurality of observers and there is a difference in visual recognition capability among the observers, each of the observers can visually recognize the video light without a sense of incongruity with respect to the observation light by adjusting the distance between the lens 55 and the display element 50 on the axis AX2.

The half mirror 60 is disposed in the internal space 40 of the housing 31, and specifically, is disposed at a position at which the axes AX1 and AX2 intersect with each other on the optical path of the video light emitted from the display element 50 and in front of the lens 55, that is, on the lower side and the −Y side. The half mirror 60 is configured of a substrate which is a parallel planar plate having plate surfaces parallel to each other. One plate surface (a first surface) of the substrate is a surface on/through which the video light is incident and the observation light is transmitted, and the other plate surface (a second surface) thereof is a surface opposite to the one plate surface and is a surface on which the observation light is incident. A reflection film 62 is provided on the one plate surface of the substrate. An antireflection film 64 is provided on the other plate surface (the second surface) of the substrate.

The one plate surface of the substrate and the reflection film 62 face the lens 55 and the objective lens 250. The one plate surface of the substrate and the reflection film 62 overlap the entire display surface 52 of the display element 50 and the lens 55 when seen in the Y direction, and overlap the optical path of the observation light before it is incident on the objective lens 250, the entire transmission region of the side wall portions 34 and 36 of the housing 31, and the objective lens 250 when seen in the Z direction.

Both the plate surfaces of the substrate and the surfaces of the reflection film 62 and the antireflection film 64 form approximately 45° with each of the axes AX1 and AX2 when seen in the X direction, and are inclined with respect to the XY plane and the XZ plane. The above angle refers to a narrow angle between the plate surface or surface and the axis. Both the plate surfaces of the substrate and the surfaces of the reflection film 62 and the antireflection film 64 move in the −Y direction as they move in the +Z direction.

A material of the substrate of the half mirror 60 is not particularly limited as long as it can transmit the observation light. The reflection film 62 reflects at least some of the video light incident from the +Y side and transmits at least some of the observation light incident from the −Z side. Due to the reflection film 62 being provided on one plate surface of the substrate, the video light can be efficiently superimposed on the observation light. The antireflection film 64 transmits substantially the overall observation light incident from the −Z side. Although the antireflection film 64 can be omitted, it is possible to prevent the observation light from being doubled by providing the antireflection film 64 on the other plate surface of the substrate.

A transmittance of the observation light in the half mirror 60 is preferably 50% or more. Thus, it is possible to curb a decrease in the transmittance of the observation light in the optical display device 101 as much as possible. A reflectance of the video light in the reflection film 62 is preferably 40% or more. As a result, it is possible to curb a decrease in an amount of video light.

When the video light may be monochromatic, video light having a wavelength corresponding to a predetermined monochromatic color may be emitted from the display surface 52 of the display element 50. In this case, the reflection film 62 may be formed to have a high reflectance only for light having a wavelength of a predetermined color and to transmit light having a wavelength other than the predetermined color. That is, in the half mirror 60, a reflectance of light having a wavelength (a first wavelength range) of a predetermined color and a reflectance of light having a wavelength (a second wavelength range different from the first wavelength range) other than the predetermined color are different from each other. The predetermined color is, for example, green or blue, but is not particularly limited as long as it can be visually recognized by the observer. Thus, it is possible to curb a decrease in the transmittance of the observation light having a wavelength other than a predetermined color in the optical display device 101.

In the first embodiment, in a state in which the display unit 11 is mounted on the end portion of the lens barrel 212 of the binocular 201 on the −Z side, the half mirror 60 is disposed on the axis AX1 of the lens group 222, and is disposed between the object to be observed and the objective lens 250 on the axis AX1. In other words, in the state in which the display unit 11 is mounted on the binocular 201, the objective lens 250 is disposed between the half mirror 60 and the eyepiece 270 on the axis AX1. Due to such a relative arrangement, the observer can approach the display unit 11 at a certain distance from the left eye EL in the Z direction, and thus can comfortably handle the display unit 11 even during observation.

The signal processing device 70 is disposed at an arbitrary position electrically connected to the display element 50, and, for example, disposed at a position not overlapping the optical path of the video light in the internal space 40 of the housing 31. The signal processing device 70 generates an electric signal of the video light based on at least text information or image information corresponding to information on an object included in the observation light, transmits the electric signal to the display element 50, and causes the video light corresponding to the electric signal to be emitted from the display surface 52 of the display element 50. In order to acquire information on the object included in the observation light, the signal processing device 70 has a function or a mechanism of, for example, receiving some of the observation light transmitted through the half mirror 60 or capturing a motion of the observer and acquiring information on a type or a state of the object by image recognition or the like. The signal processing device 70 is configured of, for example, a microcomputer or an integrated circuit in which a program for performing the operation and processing of the signal processing device 70 described above is embedded.

In order to reduce a weight of the display unit 11, the signal processing device 70 may be disposed in a smart phone or a tablet terminal device capable of communicating with the display unit 11 owned by the observer. The display unit 11 may be operated in a stand-alone manner by arranging the signal processing device 70 in the housing 31, or may be operated in a state in which the display unit 11 is connected to an external terminal device or a computer in a wired or wireless manner as described above.

In the optical display device 101 having the above-described configuration, the observation light from an object to be observed is incident on the objective lens 250 from the −Z side along the axis AX1 in a state of substantially parallel light from a distance. The observation light incident on the objective lens 250 is transmitted through the reflection surface 262b and the transmission surface 262a of the prism 262 and the transmission surface 261a of the prism 261, and is totally reflected in the −X direction by the reflection surface 261b. The observation light totally reflected in the −X direction is totally reflected in the −Z direction by the reflection surface 261c, transmitted through the transmission surface 261a and the transmission surface 262a of the prism 262, totally reflected in the −Y direction by the reflection surface 262b, totally reflected in the +Z direction by the reflection surface 262c, and transmitted through the transmission surface 262a. As described above, an image of the observation light stands upright by passing through the prisms 261 and 262. The observation light emitted from the prism 262 forms an image on a retina of the left eye EL by the eyepiece 270 and is visually recognized by the observer.

In the optical display device 101, when the video light corresponding to an electric signal from the signal processing device 70 is displayed from the display surface 52 of the display element 50 of the display unit 11, the video light is converted into substantially parallel light by the lens 55, and at least some of the video light converted into parallel light is reflected by the reflection film 62 of the half mirror 60. The video light reflected by the half mirror 60 is superimposed on the observation light incident on the objective lens 250 from the object. That is, the observation light and the video light are incident on the objective lens 250 from the optical paths aligned with each other along the axis AX1. The video light incident on the objective lens 250 travels along the same optical path as that of the observation light, an image stands upright by the prisms 261 and 262, the image is formed on the retina of the left eye EL by the eyepiece 270, and the image is visually recognized by the observer.

The display unit 11 according to the first embodiment described above includes the mounting member 21 and the housing (the second accommodation member) 31. The mounting member 21 is mounted on the lens barrel (the first accommodation member) 212 that accommodates the lens group 222 including the objective lens 250 and the eyepiece 270. The housing 31 accommodates the display element 50 that emits the video light and the half mirror (the first deflection member) 60 that deflects the video light emitted from the display element 50. In the display unit 11 of the first embodiment, the half mirror 60 is disposed on the axis AX1 of the lens group 222. According to the display unit 11 of the first embodiment, even when the binoculars 201 are, for example, binoculars that an observer is accustomed to using, the display unit 11 can be retrofitted to the binoculars 201 to superimpose an observation image visually recognized by the binoculars 201 and a video from the display element 50 so that the observer can visually recognize both the observation image and the video.

The optical display device 101 of the first embodiment includes the display unit 11 of the first embodiment and the binoculars 201 having the lens group 222 including the objective lens 250 and the eyepiece 270. According to the optical display device 101 of the first embodiment, it is possible to realize the binoculars 201 in which the display unit 11 can be retrofitted to the end portion of the lens barrel 212 on the objective lens 250 side. Further, according to the optical display device 101 of the first embodiment, the observer can visually recognize both the observation image and the image in a state in which the display unit 11 is mounted on the binoculars 201.

Although the binoculars of the polo prism type are exemplified as the binoculars 201 in the first embodiment, the binoculars on which the display unit 11 can be mounted may be binoculars of a roof prism type in which an axis of a lens group including an objective lens and an eyepiece is substantially in a straight line, binoculars of a Galileo type, or binoculars of other types. Further, the axis AX1 between the objective lens and the eyepiece may be arbitrarily moved in any of the X direction, the Y direction and the Z direction, and a shape of the axis of the lens group including the objective lens and the eyepiece in the binocular is not particularly limited. Further, the lens group may include, in addition to the objective lens, the eyepiece, and the prism, any optical element for forming an image of the observation light on the retina of the observer's eye and standing the observation image upright. In other words, the presence or absence of a configuration other than the objective lens and the eyepiece in the lens group is not particularly limited.

In addition, in the first embodiment, the display unit 11 and the mounting member 21 are attachable to and detachable from only the lens barrel 212 for the left eye, but the display unit 11 and the mounting member 21 may be attachable to and detachable from only the lens barrel 211 for the right eye, or may be attachable to and detachable from both the lens barrels 211 and 212.

### Second Embodiment

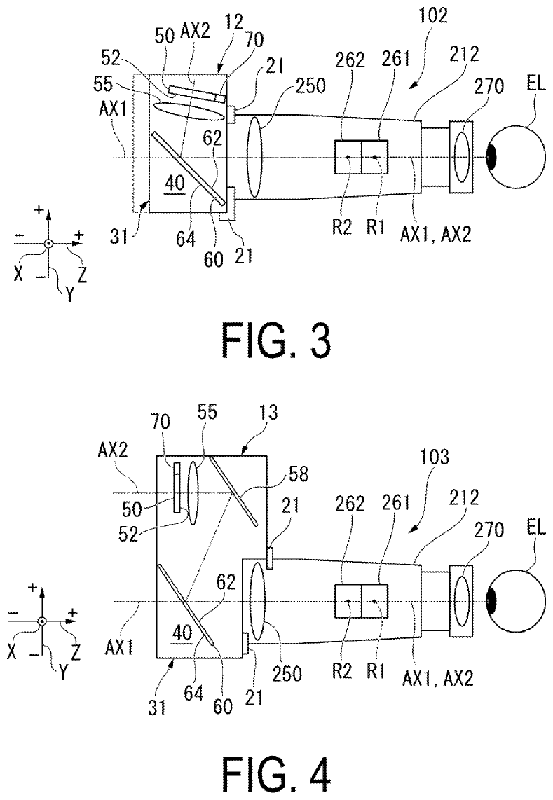

A second embodiment according to the present disclosure will be described below with reference to FIG. 3. In each of the second and subsequent embodiments, the description of content shared by the higher-order embodiment will be omitted, and the configuration of each of embodiments different from the higher-order embodiment will be described. In each of the embodiments, components common to the components of the display unit 11 and the optical display device 101 of the first embodiment are denoted by the same reference numerals as the components, and description thereof will be omitted. Further, in each of the embodiments, unless otherwise specified, the same modified example as that of the higher-order embodiment can be applied.

FIG. 3 is a schematic diagram illustrating a configuration of an optical display device 102 according to the second embodiment when seen in a direction corresponding to the D direction illustrated in FIG. 1. As illustrated in FIG. 3, the optical display device 102 according to the second embodiment includes binoculars 201 and a display unit 12 according to the second embodiment.

In FIG. 3 and subsequent drawings, a position at which the observation light and the video light are reflected by the reflection surface 261c of the prism 261 is indicated as R1, a position at which the observation light and the video light are reflected by the reflection surface 262c of the prism 262 is indicated as R2, and the axis AX1 from the position R1 to the position R2 is not illustrated. That is, although the positions R1 and R2 are illustrated at the same position in the Y direction in FIG. 3 and subsequent drawings, the position R2 is actually lower than the position R1 as described with reference to FIGS. 1 and 2, and the axis AX1 between the positions R1 and R2 is also moved in the X-direction or the Y-direction by the reflection surfaces 261c and 262c. In FIG. 3 and subsequent drawings, the shape of each of the prisms 261 and 262 is simplified.

The display unit 12 includes a mounting member 21, a housing 31, a display element 50, a lens 55, and a half mirror 60. In the display unit 12, both plate surfaces of the substrate of the half mirror 60 and the surfaces of the reflection film 62 and the antireflection film 64 form a predetermined inclination angle different from at least 45° with each of the axes AX1 and AX2 when seen in the X direction, and form an angle of 50° or more, for example. The axis AX2 is inclined with respect to an axis (not illustrated) that is parallel to the Y-direction and passes through an intersection of the axes AX1 and AX2 when seen in the X direction in accordance with an angle formed by the surfaces of the reflection films 62 of the half mirror 60 with respect to the axis AX1.

As illustrated in FIG. 3, for example, when seen in the X direction, the narrow angle formed by the axes AX1 and AX2 is less than 90°, and the axis AX2 is inclined to approach the objective lens 250 with respect to the Y direction. In this case, the half mirror 60 takes a posture in which the half mirror 60 stands upright around the intersection of the axes AX1 and AX2 to be more parallel to the Y direction than in the posture in the first embodiment. In the display unit 12, similarly to the display unit 11, the video light emitted from the display element 50 can be superimposed on the observation light. Further, in the display unit 12, since the half mirror 60 is disposed in the internal space 40 in a more upright posture than the posture in the first embodiment, it is possible to reduce the overall length of the housing 31 in the Z direction as indicated by a broken line.

Although not illustrated, the display unit 12 may include an angle adjustment mechanism capable of adjusting an inclination angle of the surface of the reflection film 62 of the half mirror 60 with respect to the axis parallel to the Y direction and passing through the intersection of the axes AX1 and AX2 when seen in the X direction. The axis AX2 between the half mirror 60 and the eyepiece 270 is shifted from the axis AX1, and a display position of the video with respect to the observation image is changed by adjusting the inclination angle of the half mirror 60. Due to this principle, the observer can easily change the display position of the video in the observation image by using the angle adjustment mechanism, and can remove the video from the observation image.

### Third Embodiment

Below, a third embodiment according to the present disclosure will be described with reference to FIG. 4. FIG. 4 is a schematic diagram illustrating a configuration of an optical display device 103 according to the third embodiment when seen in a direction corresponding to the D direction illustrated in FIG. 1. As illustrated in FIG. 4, the optical display device 103 according to the third embodiment includes binoculars 201 and a display unit 13 according to the third embodiment.

The display unit 13 includes a mounting member 21, a housing 31, a display element 50, a lens 55, a mirror (a second deflection member) 58, and a half mirror 60. In the display unit 13, a display surface 52 of the display element 50 is disposed parallel to the XY plane. The lens 55 is disposed at a position closer to the +Z side than the display element 50. The mirror 58 is disposed at a position closer to the +Z side than the lens 55. The video light emitted from the display surface 52 of the display element 50 travels in the +Z direction. The display element 50, the lens 55, and the mirror 58 overlap each other when seen in the Z direction, and are located above the half mirror 60. The mirror 58 is at a position closer to the +Z side than at least the half mirror 60.

In the display unit 13, as described in the second embodiment, the half mirror 60 takes a posture in which the half mirror 60 stands upright around the intersection of the axes AX1 and AX2 to be more parallel to the Y direction than in the posture in the first embodiment. In addition, the axis AX2 of the lens 55 is folded back by the mirror 58 and intersects the reflection film 62. A reflection surface of the mirror 58 is inclined with respect to an axis (not illustrated) parallel to the Y direction and an axis (not illustrated) parallel to the Z direction in accordance with the inclination angle of the surface of the reflection film 62 of the half mirror 60 when seen in the X direction. When the axis AX2 between the display element 50 and the mirror 58 and the axis AX1 between the half mirror 60 and the objective lens 250 are parallel to each other, the reflection surface of the mirror 58 and the surface of the reflection film 62 of the half mirror 60 are parallel to each other.

In the display unit 13, similarly to the display unit 11, the video light emitted from the display element 50 can be superimposed on the observation light. In addition, the display unit 13 further includes the mirror 58 that deflects the video light from the display element 50 toward the half mirror 60, and it is possible to reduce the overall length in the Z direction of at least a portion of the housing 31 that overlaps the lens barrel 212 when seen in the Z direction by appropriately setting the inclination angle of the half mirror 60, a separation distance between the display element 50 and the mirror 58, and the like. As long as the optical path of the video light is not obstructed, the mirror 58 may be located closer to the +Z side than the objective lens 250 in a state in which the display unit 13 is mounted on the binoculars 201. As a result, it is possible to further reduce the overall length in the Z direction of the portion of the housing 31 that overlaps the lens barrel 212 when seen in the Z direction.

### Fourth Embodiment

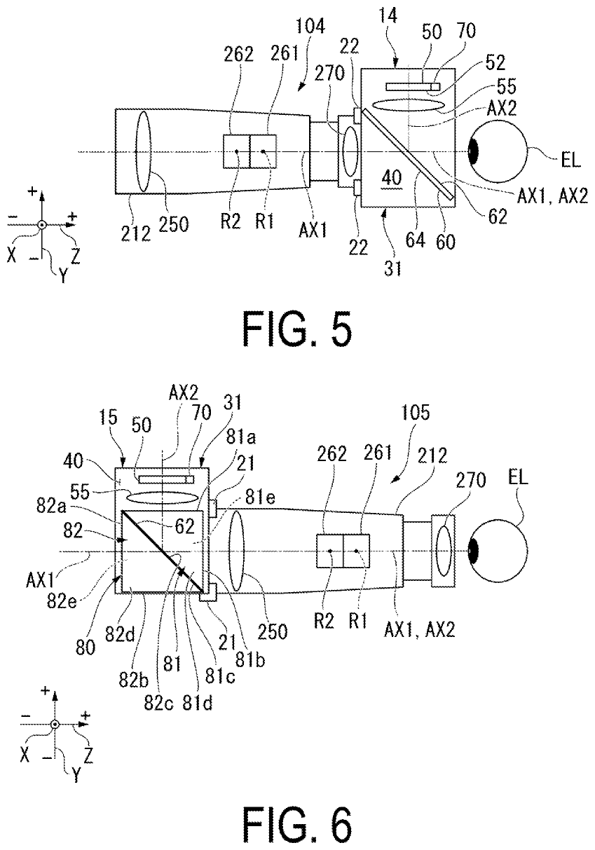

A fourth embodiment according to the present disclosure will be described below with reference to FIG. 5. FIG. 5 is a schematic diagram illustrating a configuration of an optical display device 104 according to the fourth embodiment when seen in a direction corresponding to the direction D illustrated in FIG. 1. As illustrated in FIG. 5, the optical display device 104 according to the fourth embodiment includes binoculars 201 and a display unit 14 according to the fourth embodiment.

The display unit 14 includes a mounting member 22, a housing 31, a display element 50, a lens 55, and a half mirror 60.

The mounting member 22 is a member that is mounted on an end portion of the lens barrel 212 of the binoculars 201 on the image side from the image side, that is, the +Z side, and is attachable to and detachable from the lens barrel 212. The configuration and shape of the mounting member 22 are not particularly limited as long as the mounting member 22 can be attached to and detached from the end portion of the lens barrel 212 on the image side. The mounting member 22 is, for example, a member that can lock the end portion of the lens barrel 212 on the image side from the outside in a radial direction. When seen in the Z direction, the mounting member 22 does not overlap at least the optical path of the observation light after passing through the eyepiece 270.

In the fourth embodiment, in a state in which the display unit 14 is mounted on an end portion of the lens barrel 212 of the binocular 201 on the +Z side, the half mirror 60 is disposed on the axis AX1 of the lens group 222, and is disposed between the eyepiece 270 and the left eye EL of the observer on the axis AX1. That is, in a state in which the display unit 14 is mounted on the binocular 201, the eyepiece 270 is disposed between the objective lens 250 and the half mirror 60 on the axis AX1. With such a relative arrangement, in the optical display device 104, for example, even when a display magnification is variable in the binoculars 201 and the observer arbitrarily changes the display magnification, a magnification of the video does not change and the visibility of the video is maintained. On the other hand, in the optical display device 104, when the observer arbitrarily changes the display magnification of the binoculars 201, the magnification of the video also changes.

### Fifth Embodiment

A fifth embodiment according to the present disclosure will be described below using FIG. 6. FIG. 6 is a schematic diagram illustrating a configuration of an optical display device 105 according to the fifth embodiment when seen in a direction corresponding to the D direction illustrated in FIG. 1. As illustrated in FIG. 6, the optical display device 105 according to the fifth embodiment includes binoculars 201 and a display unit 15 according to the fifth embodiment.

The display unit 15 includes a mounting member 21, a housing 31, a display element 50, a lens 55, and a cube-type beam splitter (a first deflection member) 80. In other words, the display unit 15 is a device including the beam splitter 80 instead of the half mirror 60 in the display unit 11.

The beam splitter 80 includes a rectangular prism (a first prism) 81, a rectangular prism (a second prism) 82, and a reflection film 62. The rectangular prism 81 has equilateral surfaces 81a and 81b, a hypotenuse surface 81c, and side surfaces 81d and 81e. The equilateral surface (a first incident portion) 81a has a substantially square shape when seen in the Y direction, and is disposed parallel to the XZ plane. The equilateral surface (an emission portion) 81b is orthogonal to the equilateral surface 81a, has a substantially square shape when seen in the Z direction, and is disposed in parallel to the XY plane. The hypotenuse surface 81c overlaps the equilateral surfaces 81a and 81b when seen in the Y direction and the Z direction, but is inclined with respect to each of the equilateral surfaces 81a and 81b and is inclined to move in the −Y direction as moving in the +Z direction. The side surfaces 81d and 81e have a right-angled isosceles triangular shape when seen in the X direction.

The rectangular prism 82 is formed to have substantially the same size and shape as the rectangular prism 81, and has equilateral surfaces 82a and 82b, a hypotenuse surface 82c, and side surfaces 82d and 82e. The equilateral surface (a second incidence portion) 82a has a substantially square shape when seen in the Z direction, and is disposed parallel to the XY plane. The equilateral surface 82b is orthogonal to the equilateral surface 82a, has a substantially square shape when seen in the Y direction, and is disposed in parallel to the XZ plane. The hypotenuse surface 82c overlaps the equilateral surfaces 82a and 82b when seen in the Y direction and the Z direction, but is inclined with respect to each of the equilateral surfaces 82a and 82b and is inclined to move in the −Y direction as moving in the +Z direction. The hypotenuse surface 82c is parallel to the hypotenuse surface 81c of the rectangular prism 81. The side surfaces 82d and 82e have a right-angled isosceles triangular shape when seen in the X direction.

An antireflection film (not illustrated) is provided on the equilateral surfaces 81a and 81b of the rectangular prism 81. Similarly, an antireflection film (not illustrated) is provided on the equilateral surfaces 82a and 82b of the rectangular prism 82. A material of each of the rectangular prisms 81 and 82 is not particularly limited as long as the observation light and the video light can be transmitted therethrough, and is, for example, optical glass, quartz, or the like.

The reflection film 62 is interposed between the hypotenuse surface 81c of the rectangular prism 81 and the hypotenuse surface 82c of the rectangular prism 82, and is in close contact with the hypotenuse surfaces 81c and 82c. The beam splitter 80 is formed in a cubic shape.

In the optical display device 105, the video light emitted from the display surface 52 of the display element 50 of the display unit 15 and converted into substantially parallel light by the lens 55 is incident on the rectangular prism 81 of the beam splitter 80 from the equilateral surface 81a of the rectangular prism 81. At least some of the video light incident on the rectangular prism 81 is transmitted through the hypotenuse surface 81c and reflected by the reflection film 62. At least some of the rest of the video light incident on the rectangular prism 81 is sequentially transmitted through the reflection film 62 and the equilateral surface 82b of the rectangular prism 82. The video light reflected by the reflection film 62 is incident on the rectangular prism 81 from the hypotenuse surface 81c and is emitted from the equilateral surface 81b. The observation light from an object to be observed is incident on the rectangular prism 82 from the equilateral surface 82a, is emitted from the hypotenuse surface 82c, and is then incident on the reflection film 62. Some of the observation light emitted from the rectangular prism 82 is transmitted through the reflection film 62, is incident on the rectangular prism 81 from the hypotenuse surface 81c, is emitted in the +Z direction from the equilateral surface 81b, and is incident on the objective lens 250. The video light emitted from the equilateral surface 81b of the rectangular prism 81 of the beam splitter 80 is superimposed on the observation light incident on the objective lens 250 from the beam splitter 80. As in the first embodiment, the observation light and the video light are incident on the objective lens 250 from the optical paths aligned with each other along the axis AX1.

In the optical display device 105, since the cube-type beam splitter 80 is used to superimpose the video light on the observation light, it is considered that the length of the optical path of the video light is longer than that in the configuration using the half mirror 60 as in the optical display device 101 or the like. However, in the optical display device 105, the beam splitter 80 is disposed in a stable state in the housing 31 with respect to the configuration using the half mirror 60, and it is possible to increase the superimposition accuracy of the video light with respect to the observation light. It is possible to curb occurrence of displacement in the relative arrangement between the lens 55 and the beam splitter 80 by fixing the lens 55 to the beam splitter 80 when an external impact is applied during an assembly process of the display unit 15 or when the display unit 15 is attached to or detached from the lens barrel 212.

### Sixth Embodiment

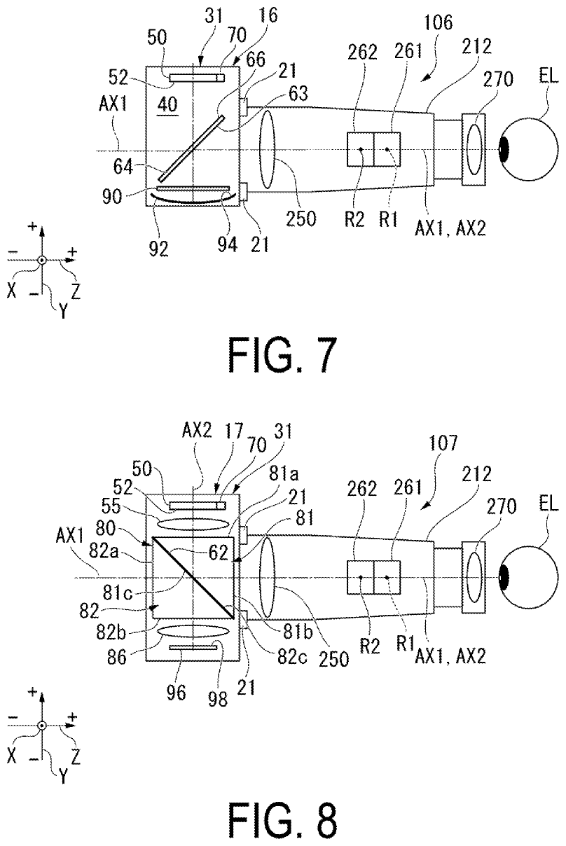

Next, a sixth embodiment of the present disclosure will be described with reference to FIG. 7. FIG. 7 is a schematic diagram illustrating a configuration of an optical display device 106 according to the sixth embodiment when seen in a direction corresponding to the D direction illustrated in FIG. 1. As illustrated in FIG. 7, the optical display device 106 according to the sixth embodiment includes binoculars 201 and a display unit 16 according to the sixth embodiment.

The display unit 16 includes a mounting member 21, a housing 31, a display element 50, a polarizing mirror 66, a quarter-wave plate 90, and a curved mirror 92. That is, the display unit 16 is a device including the curved mirror (a reflection member) 92 instead of the lens 55 and the polarizing mirror 66 instead of the half mirror 60 in the display unit 11. In addition, in the display unit 16, a reflection film 63 is provided on one plate surface of a substrate of the polarizing mirror 66. An antireflection film 64 is provided on the other plate surface of the substrate of the polarizing mirror 66. For example, the reflection film 63 transmits S-polarized video light (first polarized light) and reflects P-polarized video light (second polarized light). Both the plate surfaces of the substrate of the polarizing mirror 66 and the surfaces of the reflection film 63 and the antireflection film 64 move in the +Y direction as they move in the +Z direction, and take a posture obtained by rotating the posture of the half mirror 60 described in the first embodiment clockwise by 90° about the intersection of the axes AX1 and AX2 when seen in the −X direction.

The quarter-wave plate 90 is disposed at a position closer to the −Y side than the polarizing mirror 66. A plate surface of the quarter-wave plate 90 is parallel to the XZ plane. The curved mirror 92 is disposed at a position closer to the −Y side than the quarter-wave plate 90. Therefore, the quarter-wave plate 90 is disposed between the polarizing mirror 66 and the curved mirror 92 on the optical path of the video light. The curved mirror 92 is provided at a position on the −Y side opposite to the display element 50 located at a position on the +Y side with respect to the polarizing mirror 66. In the display unit 16, the axis AX2 is equivalent to an optical axis of the video light emitted from the display surface 52 of the display element 50.

The curved mirror 92 is formed of a substrate which is a curved plate protruding to the −Y side in the Z direction and the X direction. A reflection film 94 is provided on a curved surface of the substrate on the +Y side. The reflection film 94 faces the quarter-wave plate 90 and reflects substantially the whole of the video light incident from the +Y side.

In the display unit 16, for example, the S-polarized video light (first polarized light) is emitted from the display surface 52 of the display element 50. The polarizing mirror 66 transmits the S-polarized video light incident from the display element 50 toward the curved mirror 92 disposed on the −Y side. The S-polarized video light transmitted through the polarizing mirror 66 passes through the quarter-wave plate 90 and is converted into circularly polarized video light. The S-polarized and the circularly polarized light from the display surface 52 of the display element 50 to the curved mirror 92 is diffused light based on a light emitting point of the display surface 52. The circularly polarized video light transmitted through the polarizing mirror 66 and incident on the curved mirror 92 is reflected by the reflection film 94 of the curved mirror 92 toward the polarizing mirror 66 on the +Y side. The circularly polarized video light reflected by the curved mirror 92 becomes parallel light, passes through the quarter-wave plate 90, is converted into the P-polarized video light (the second polarized light) different from the S-polarized video light, and is incident on the reflection film 63 of the polarizing mirror 66. The P-polarized video light incident on the reflection film 63 is reflected in the +Z direction and is superimposed on the observation light that is emitted from the object to be observed, transmitted through the polarizing mirror 66, and incident on the objective lens 250. As in the first embodiment, the observation light and the video light are incident on the objective lens 250 from the optical paths aligned with each other along the axis AX1.

In the optical display device 106, the video light emitted from the display element 50 of the display unit 16 can be superimposed on the observation light with little loss. In addition, in the optical display device 106, there is a possibility that the display unit 16 can be configured of the same components as the lens barrel 212 and the lens group 222 of the binoculars 201, and in this case, it is possible to reduce the total number of components.

In the optical display device 106, the P-polarized video light (the first polarized light) may be emitted from the display surface 52 of the display element 50, and the circularly polarized video light reflected by the curved mirror 92 may be converted into the S-polarized video light (the second polarized light) when passing through the quarter-wave plate 90.

### Seventh Embodiment

Next, a seventh embodiment of the present disclosure will be described with reference to FIG. 8. FIG. 8 is a schematic diagram illustrating a configuration of an optical display device 107 according to the seventh embodiment when seen in a direction corresponding to the D direction illustrated in FIG. 1. As illustrated in FIG. 8, the optical display device 107 according to the seventh embodiment includes binoculars 201 and a display unit 17 according to the seventh embodiment.

The display unit 17 includes a mounting member 21, a housing 31, a display element 50, a lens 55, a beam splitter 80, a lens 86, and an image sensor (a light receiving element) 96. The display unit 17 is a device further including a lens 86 and an image sensor 96 in addition to the configuration of the display unit 15. In the following, a configuration of the display unit 17 different from that of the display unit 15 will be described, and description of the contents common to the display unit 17 and the display unit 15 will be omitted.

The lens 86 is disposed at a position closer to the −Y side than the beam splitter 80. The image sensor 96 is disposed at a position closer to the −Y side than the lens 86. A light-receiving surface 98 of the image sensor 96 is parallel to the XZ plane and faces the lens 86. The lens 86 and the image sensor 96 are provided at a position on the −Y side opposite to the display element 50 located at the position on the +Y side with respect to the beam splitter 80. The image sensor 96 receives the observation light incident from the beam splitter 80 as described below. The image sensor 96 has a function of capturing observation light and is connected to the signal processing device 70 in a wired or wireless manner.

In the optical display device 107, the observation light from an object to be observed is incident on the rectangular prism 82 from the equilateral surface 82a, is emitted from the hypotenuse surface 82c, and is incident on the reflection film 62. Some of the observation light emitted from the rectangular prism 82 in the +Z direction passes through the reflection film 62, is emitted from the equilateral surface 81b in the +Z direction, and is superimposed on the video light reflected by the reflection film 62 in the +Z direction. As in the fifth embodiment, in the objective lens 250, the observation light and the video light are incident on the objective lens 250 from optical paths aligned with each other along the axis AX1. At least some of the rest of the observation light emitted from the rectangular prism 82 in the +Z direction is reflected by the reflection film 62 in the −Y direction, is incident on the rectangular prism 82, and is emitted from the equilateral surface 82b. The observation light emitted in the −Y direction from the rectangular prism 82 forms an image on the light receiving surface 98 of the image sensor 96 by the lens 86. That is, some of the observation light incident on the rectangular prism 82 from the equilateral surface (the second incident portion) 82a is incident on the image sensor 96.

In the optical display device 107, the light receiving surface 98 of the image sensor 96 is disposed at a position facing the display surface 52 of the display element 50 via the lens 55, the beam splitter 80, and the lens 86 in the display unit 17. According to the optical display device 107, it is possible to capture and acquire information on an object included in the observation light in real time using the image sensor 96 and to transmit the information to the signal processing device 70. Thus, for example, the observation image observed by the observer can be fed back and confirmed by the signal processing device 70.

### Eighth Embodiment

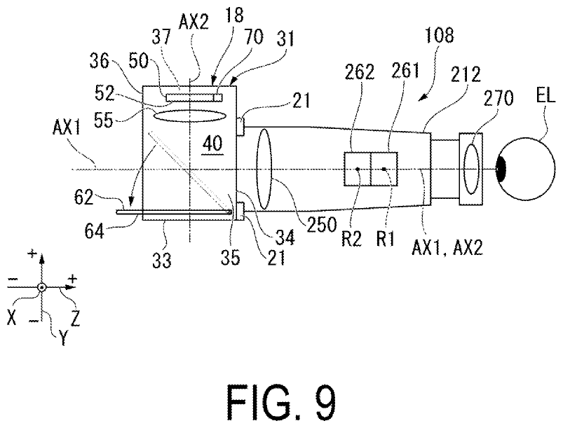

Next, an eighth embodiment of the present disclosure will be described with reference to FIG. 9. FIG. 9 is a schematic diagram illustrating a configuration of an optical display device 108 according to the eighth embodiment when seen in a direction corresponding to the D direction illustrated in FIG. 1. As illustrated in FIG. 9, the optical display device 108 according to the eighth embodiment includes binoculars 201 and a display unit 18 according to the eighth embodiment.

The display unit 18 includes a mounting member 21, a housing 31, a display element 50, a lens 55, a half mirror 60, and an angle adjustment mechanism (not illustrated). The display unit 18 is a device further including an angle adjustment mechanism in addition to the configuration of the display unit 11. Hereinafter, a configuration of the display unit 18 different from that of the display unit 11 will be described, and the description of the contents common to the display unit 17 and the display unit 11 will be omitted.

The half mirror 60 is disposed in the internal space 40 of the housing 31 to be rotatable about a rotation axis (not illustrated) passing through a lower end of the half mirror 60, that is, end portions on the +Z side and the −Y side and parallel to the X direction.

The angle adjustment mechanism adjusts an angle of the plate surface of the substrate of the half mirror 60 and the surface of the reflection film 62 with respect to the optical axis of the video light emitted from the display surface 52 of the display element 50 and incident on the half mirror 60, that is, the axis AX2 between the display element 50 and the half mirror 60 to be larger than 45° and equal to or smaller than 90°. The half mirror 60 indicated by a two dot chain line in FIG. 9 represents a state in which the angles of the plate surface of the substrate of the half mirror 60 and the surface of the reflection film 62 is 45° with respect to the optical axis of the video light incident on the half mirror 60, that is, a state in which the half mirror 60 is disposed similarly to the display unit 11. The half mirror 60 indicated by a solid line in FIG. 9 represents a state in which the angles of the plate surface of the substrate of the half mirror 60 and the surface of the reflection film 62 with respect to the optical axis of the video light incident on the half mirror 60 is substantially 90°. The angle adjustment mechanism may include, for example, a shaft member and an angle adjustment member. The shaft member supports the lower end of the half mirror 60, extends in the X direction, and protrudes to the outside of at least one of the side wall portions 35 and 37 of the housing 31. The angle adjustment member can be amounted on an end portion of the shaft member protruding to the outside of at least one of the side wall portions 35 and 37, and can be rotated in the YZ plane by an observer's hand, for example. The configuration of the angle adjustment mechanism is not particularly limited as long as the angle of the half mirror 60 with respect to the optical axis of the video light incident on the half mirror 60 can be adjusted to be larger than 45° and equal to or smaller than 90°.

In the housing 31, at least the side wall portion 36 in a region in which the half mirror 60 may interfere when the angle of the half mirror 60 with respect to the optical axis of the video light incident on the half mirror 60 is adjusted as described above by the angle adjustment member is removed.

In the optical display device 108, the observer can adjust the angle of the half mirror 60 with respect to the optical axis of the video light incident on the half mirror 60 to be larger than 45° and equal to or smaller than 90° using the angle adjustment member. According to the optical display device 108, when the angle of the half mirror 60 with respect to the optical axis of the video light incident on the half mirror 60 is set to approximately 90° (larger than 45° and equal to or smaller than 90°), no video is displayed on the observation image, and thus the observer visually recognizes the original bright observation image of the binoculars 201. Therefore, according to the optical display device 108, it is possible to easily switch between a state in which a video is superimposed on an observation image and these images are visually recognized and a state in which only the observation image is visually recognized.

Although the preferred embodiments of the present disclosure have been described in detail above, the present disclosure is not limited to the specific embodiments, and various modifications and changes can be made within the scope of the gist of the present disclosure described in the claims. In addition, constituent elements of the plurality of embodiments can be appropriately combined.

For example, in each of the above-described embodiments, the binoculars are exemplified as the long distance viewing device of the present disclosure. However, the long distance viewing device of the present disclosure may be a monocular. In addition, the long distance viewing device of the present disclosure may be various telescopes, various microscopes, or the like, and widely includes devices configured to visually recognize a non-observation object far from the objective lens.

What is claimed is:

1. A display unit comprising:
a mounting member mounted on a first accommodation member configured to accommodate a lens group including an objective lens and an eyepiece;
a display element that emits video light;
a first deflection member that deflects the video light emitted from the display element; and
a second accommodation member configured to accommodate the display element and the first deflection member, wherein
the second accommodation member is mounted on the first accommodation member, such that the first deflection member is disposed on an axis of the lens group, by the mounting member, and
when the first deflection member is disposed on the axis of the lens group, an axis of the video light deflected by the first deflection member overlaps with the axis of the lens group.

2. The display unit according to claim 1, wherein
a reflection film that reflects at least a portion of the video light is provided at a first surface of the first deflection member on which the video light is incident, and
an antireflection film is provided at a second surface of the first deflection member on a side opposite to the first surface.

3. The display unit according to claim 1, wherein
a reflectance of light having a first wavelength range and a reflectance of light having a second wavelength range different from the first wavelength range in the first deflection member are different from each other.

4. The display unit according to claim 1, further comprising a second deflection member configured to deflect the video light from the display element toward the first deflection member.

5. The display unit according to claim 1, wherein
the first deflection member includes:
a first prism having a first incident portion on which the video light from the display element is incident;
a second prism having a second incident portion on which observation light from an outside scene is incident; and
a reflection film configured to reflect the video light incident from the first incident portion and to transmit light incident from the second incident portion, and
the first prism includes an emission portion that emits the video light reflected by the reflection film and the observation light transmitted through the reflection film.

6. The display unit according to claim 1, further comprising:
a reflection member provided on a side opposite to the display element with respect to the first deflection member and configured to reflect the video light transmitted through the first deflection member toward the first deflection member; and
a quarter-wave plate disposed between the first deflection member and the reflection member, wherein
the first deflection member transmits first polarized light toward the reflection member and reflects second polarized light having polarization different from that of the first polarized light.

7. The display unit according to claim 5, further comprising a light receiving element provided on a side opposite to the display element with respect to the first deflection member, wherein
some a portion of the observation light incident on the second prism from the second incident portion is incident on the light receiving element.

8. The display unit according to claim 1, further comprising an adjustment member configured to adjust an angle of the first deflection member with respect to an optical axis of the video light incident on the first deflection member to be larger than 45° and equal to or smaller than 90°.

9. An optical display device comprising:
the display unit according to claim 1; and
a long distance viewing device including the lens group.

10. The optical display device according to claim 9, wherein
the objective lens is disposed between the first deflection member and the eyepiece on the axis.

11. The optical display device according to claim 9, wherein
the eyepiece is disposed between the objective lens and the first deflection member on the axis.
